(19) United States
(12) Patent Application Publication
(10) Pub. No.: US 2026/0138097 A1
(43) Pub. Date: May 21, 2026

(54) HOLLOW FIBER MEMBRANE MODULE HOUSING

(71) Applicant: Wine to Water, Boone, NC (US)

(72) Inventors: Timothy Cox, JR., Boone, NC (US); Dickson Hendley, Boone, NC (US)

(21) Appl. No.: 18/963,837

(22) Filed: Nov. 29, 2024

Related U.S. Application Data
(63) Continuation of application No. 18/950,664, filed on Nov. 18, 2024, now abandoned.

(51) Int. Cl. B01D 69/10

(52) U.S. Cl. CPC B01D 69/108; B01D 2313/02; B01D 2313/14; B01D 2313/2062

(57) ABSTRACT

The present disclosure provides hollow fiber membrane module (HFM modules) housings that allow for cleaning and reuse of HFM modules. The HFM module housing may comprise a proximal portion, a distal portion, an HFM module located in the proximal portion and the distal portion interior and that may comprise a plurality of porous filaments, and a latch/lock removably attaching the distal portion proximal end to the proximal portion distal end. Optionally, the proximal portion and the distal portion comprise mating threads. Optionally, the proximal and/or distal portion comprise fins to allow a user to screw and unscrew the proximal portion relative to the distal portion for HFM module cleaning and replacement.

### BACKGROUND

### Technical Field

The present invention relates to housings for hollow fiber membrane modules.

### Background of the Invention

Hollow fiber membrane filters (HFMF) serve to remove minute particles, rust, and turbidity from water. HFMFs typically comprise two components: 1) a hollow fiber membrane module (HFM module) that typically comprises a filament housing or inner shell that is typically comprised of PVC or other plastic and holds thousands of long, flexible, porous filaments ranging in size from, for example, 1-3.5 millimeters wide, that are held in place by resin in the filament housing; and 2) a HFM module housing (or outer shell) that holds the HFM module and is made up of two halves that are permanently attached to each other (e.g., by hot point or sonic welding).

Dirty water is typically fed into the proximal end of the HFM module housing, through the proximal end of the HFM module, and into the filaments. Then, water passes out the pores of the filaments (leaving the microorganisms and other contaminants behind), exits the distal end of the HFM module and then exits the distal end of the HFM module housing. Typically, the proximal end is above the distal end if the water is gravity fed.

Examples of HFM modules include those produced by NOK Corporation (Minato, Tokyo, Japan), among other manufacturers.

HFM modules lose their utility over time as contaminants build up in the pores. Unfortunately, because the HFM module halves are permanently attached, the user is unable to access the HFM module to backwash it and clean it. Thus, the user's only option is to discard the HFM module, leading to waste.

Thus, there is a need for housings that allow users to access and backwash the HFM module.

### SUMMARY OF THE INVENTION

The present disclosure provides housings for HFM modules as described herein.

### BRIEF DESCRIPTION OF THE DRAWINGS

FIG. 1 illustrates a side perspective view of an HFM module housing of one embodiment of the present invention.

FIG. 2 illustrates a side, perspective view of the distal portion of the HFM module housing of FIG. 1.

FIG. 3 illustrates a side, perspective view of the proximal portion of the HFM module housing of FIG. 1.

FIG. 4A illustrates a side, elevation view of the proximal portion of FIG. 3 with the tab not bent up.

FIG. 4B illustrates a side, elevation view of the proximal portion of FIG. 3 with the tab partially bent up.

FIG. 4C illustrates a side, elevation view of the proximal portion of FIG. 3 with the tab bent up.

FIG. 4D illustrates a side, perspective view of the proximal portion of FIG. 3 with the tab not bent up.

FIG. 4E illustrates a side, perspective view of the proximal portion of FIG. 3 with the tab partially bent up.

FIG. 4F illustrates a side, perspective view of the proximal portion of FIG. 3 with the tab bent up.

FIG. 5 illustrates a side, exploded perspective view of the HFM module housing of FIG. 1.

FIG. 6 illustrates a side, exploded perspective view of the HFM module housing of FIG. 5, with the arrows showing how the proximal portion is being rotated clockwise relative to the distal portion.

FIG. 7 illustrates a side, exploded perspective view of the HFM module housing of FIG. 6, with the arrows showing how the proximal portion is being rotated clockwise relative to the distal portion.

FIG. 8 illustrates a side, exploded perspective view of the HFM module housing of FIG. 7, with the arrows showing how the proximal portion is being rotated clockwise relative to the distal portion.

FIG. 9 illustrates a side, exploded perspective view of the HFM module housing of FIG. 8, with the tab seated in the recess.

FIG. 9A illustrates a closeup view of the area in FIG. 9 with the tab seated in the recess.

FIG. 10 illustrates a side, exploded perspective view of the HFM module housing of FIG. 9, with the arrows showing how the proximal portion is being rotated counter-clockwise relative to the distal portion to remove the tab from the recess.

FIG. 11 illustrates a side, exploded perspective view of the HFM module housing of FIG. 10, with the arrows showing how the proximal portion is being rotated counter-clockwise relative to the distal portion.

FIG. 12 illustrates a perspective fully exploded perspective view of the HFM module housing of FIG. 1.

FIG. 13 illustrates a top plan view of the HFM module housing of FIG. 1.

FIG. 14 illustrates a sectional view of the HFM module housing of FIG. 13 taken along line 14-14 of FIG. 13.

FIG. 15 illustrates a sectional view of the HFM module housing of FIG. 13 taken along line 14-14 of FIG. 13, with proximal portion rotated counter-clockwise relative to the distal portion to remove the tab from the recess.

### DETAILED DESCRIPTION

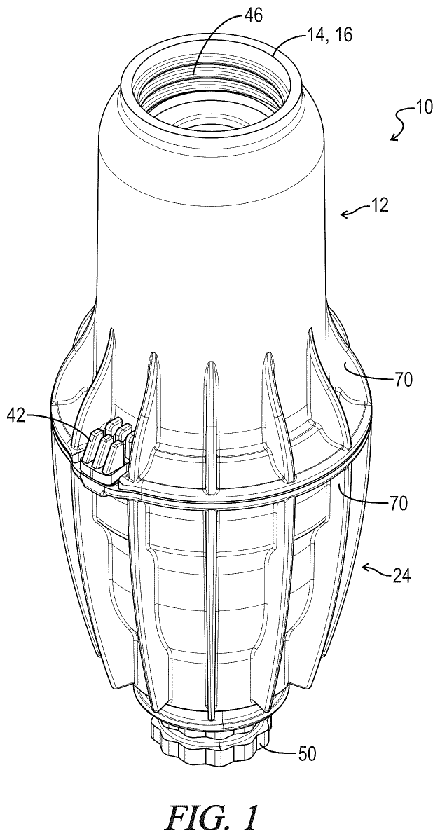

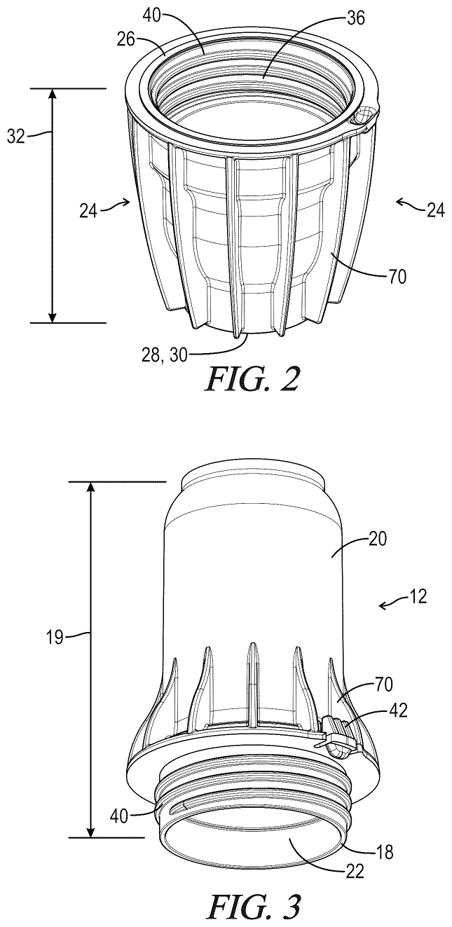

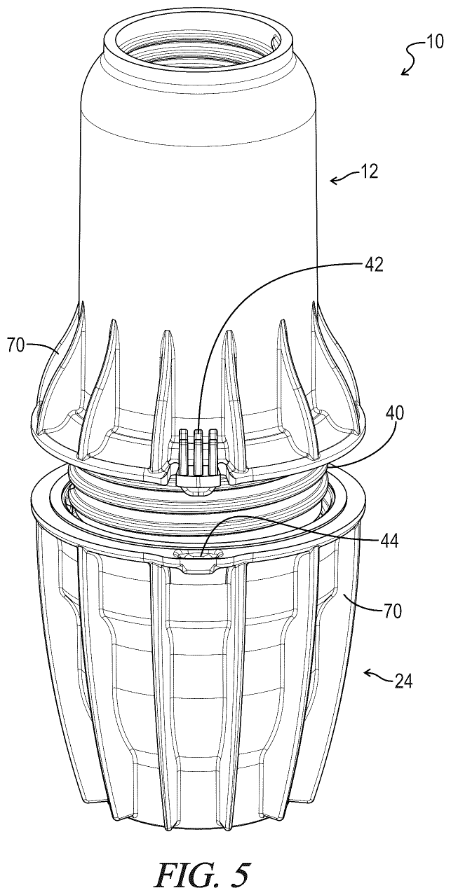

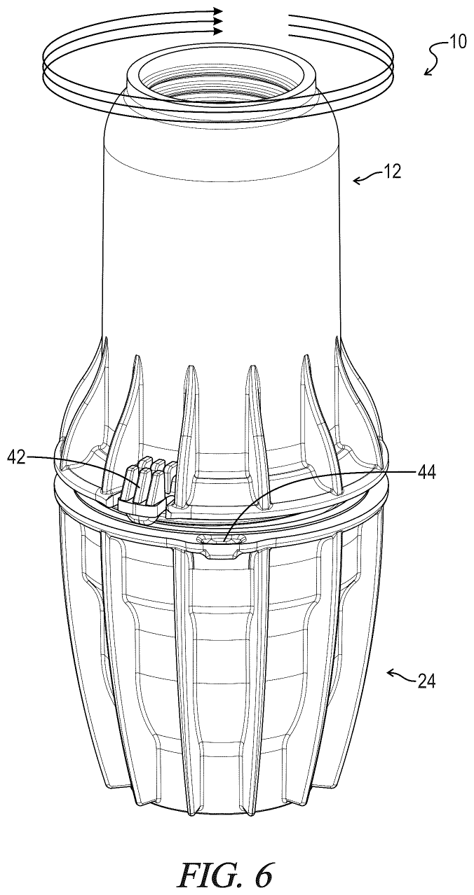

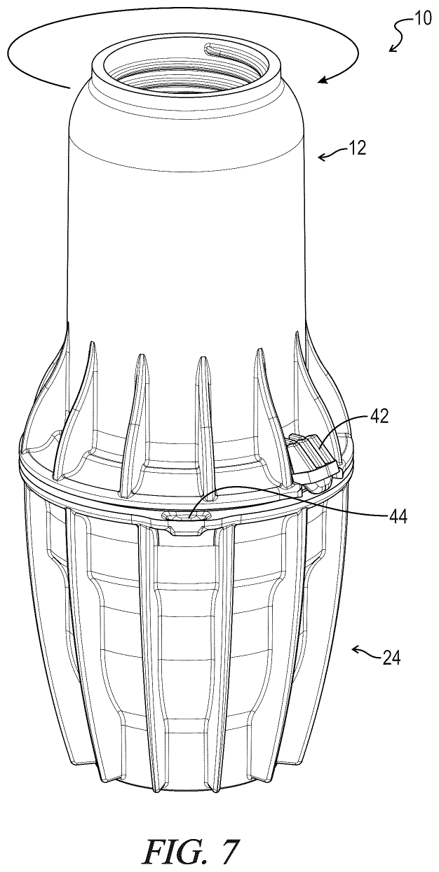

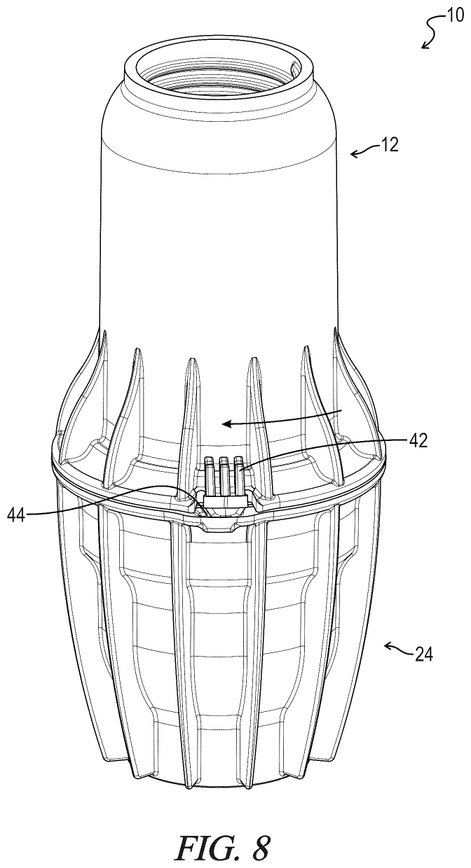

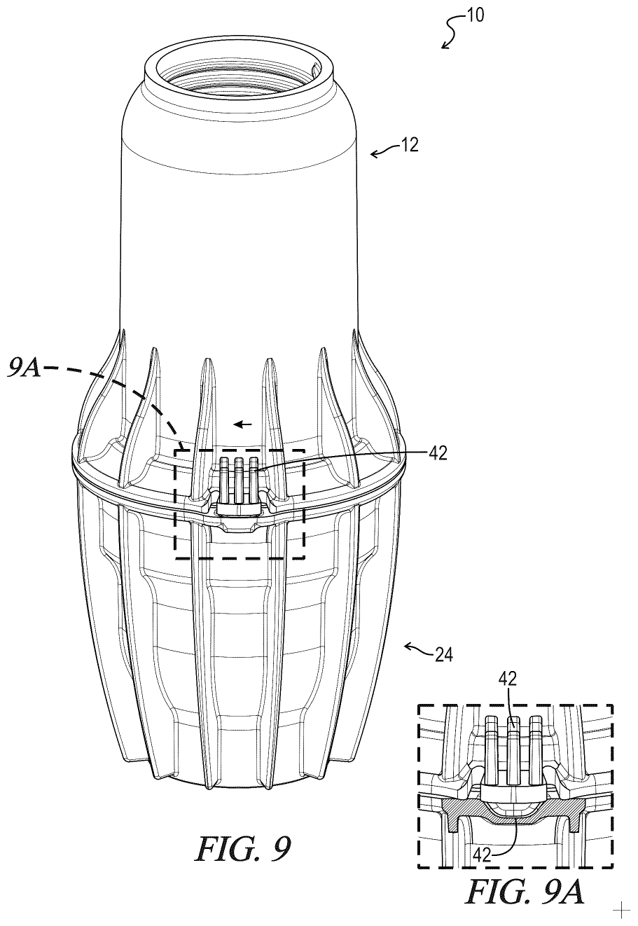

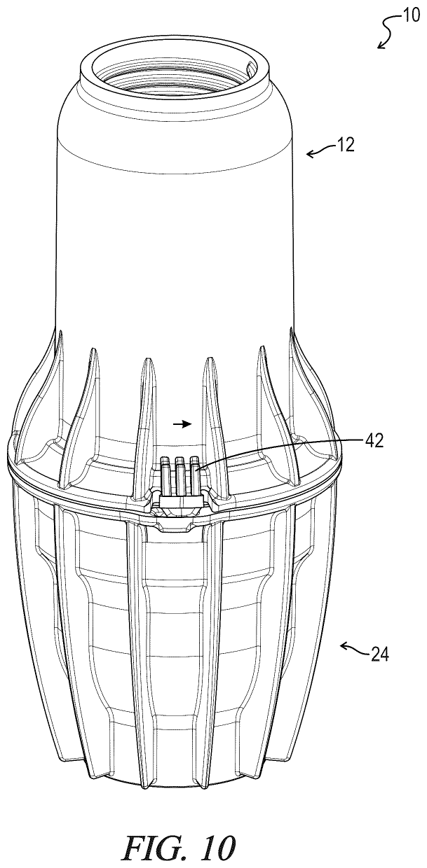

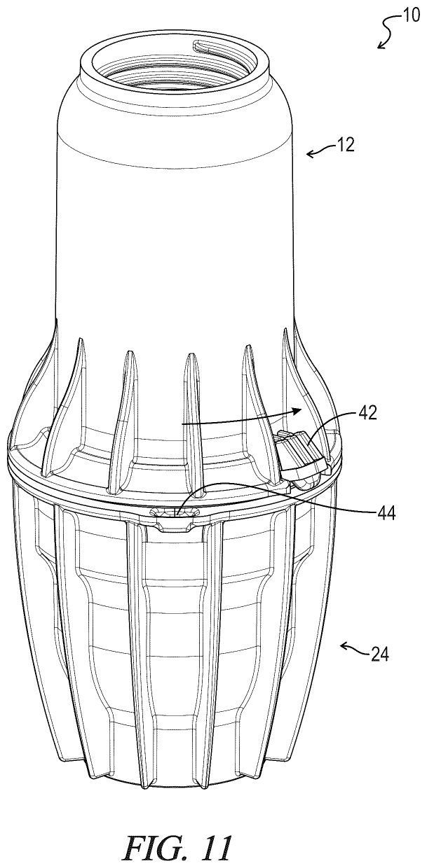

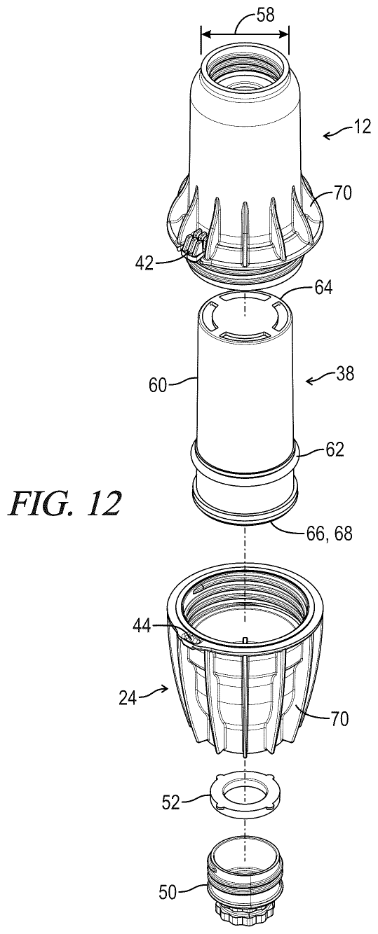

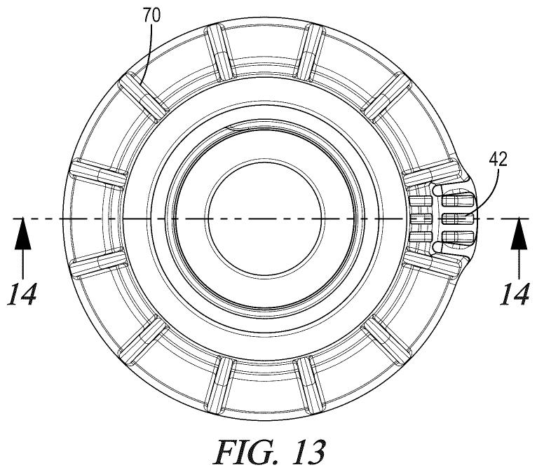

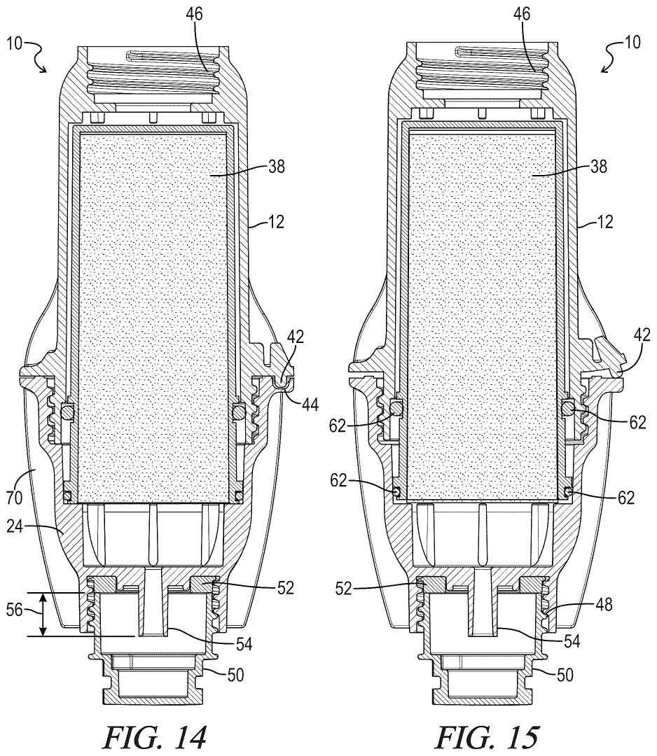

With reference to FIGS. 1-15, the present disclosure provides housings for hollow fiber membrane modules (HFM modules). In the drawings, not all reference numbers are included in each of the drawings for the sake of clarity. FIGS. 1-15 are drawn generally to scale, however, it will be appreciated that other dimensions are possible.

Referring further to FIGS. 1-15, in some embodiments, the HFM module housing 10 comprises a proximal portion 12 that may comprise a proximal portion proximal end 14 that may comprise a water inlet 16, a proximal portion distal end 18, a proximal portion length 19 extending from the proximal portion proximal end 14 to the proximal portion distal end 18, a proximal portion exterior 20, and a proximal portion interior 22. The HFM module housing 10 may further comprise a distal portion 24 that may comprise a distal portion proximal end 26, a distal portion distal end 28 that may comprise a water outlet 30, a distal portion length 32 extending from the distal portion proximal end 26 to the distal portion distal end 28, a distal portion exterior 34, and a distal portion interior 36 that may be adjacent and distal to the proximal portion interior 22. The HFM module housing 10 may further include a hollow fiber membrane module 38 (HFM module) located in the proximal portion 12 and the distal portion interior 36 and that may comprise a plurality of porous filaments. The HFM module housing 10 may further include a latch/lock removably attaching the distal portion proximal end 26 to the proximal portion distal end 18.

Optionally, as shown in FIGS. 1-15, the latch/lock comprises mating threads 40 located on the proximal portion distal end 18 and the distal portion proximal end 26. Optionally, the proximal portion interior 22 and the distal portion interior 36 form a housing interior, and the mating threads 40 are located in the housing interior.

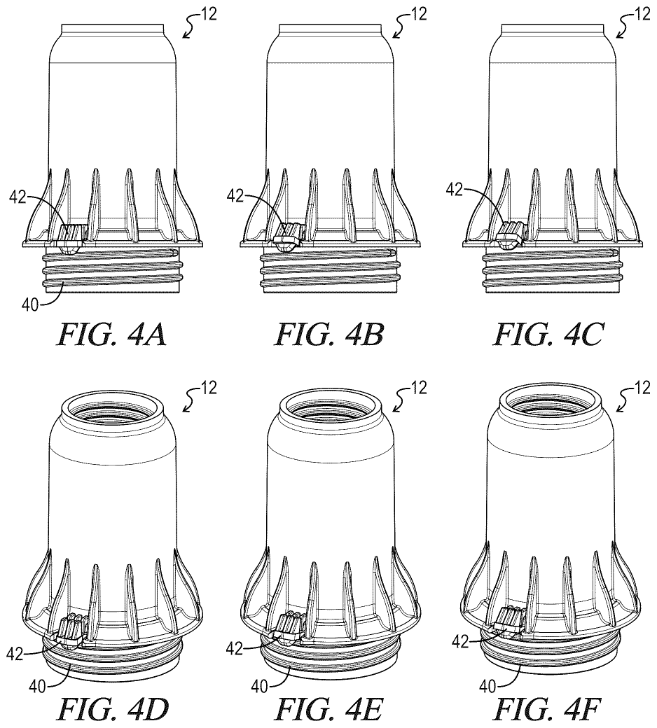

Optionally, as shown in FIGS. 1-15, the latch/lock is an interference latch system. For example, in the illustrated embodiment, and as best shown in FIGS. 4-11, the interference latch system comprises a tab 42 located on the proximal portion 12 adjacent the proximal portion distal end 18 and a recess/divot 44 removably receiving the tab 42 and located on the distal portion 24 adjacent the distal portion proximal end 26. The tab has a living hinge pivot point that deflects to allow the tab 42 to fall into the recess 44 after a pre-determined number of rotations of the proximal portion 12 clockwise relative to the distal portion 24. In the illustrated embodiment, the tab 42 is disengaged from the recess/divot 44 by rotating the proximal portion 12 counterclockwise relative to the distal portion 24. It will be appreciated that other locks/latches may be used such as a snap latching system (similar to a prescription pill bottle), a dog and pawl latching system, where turning the latch engages a feature (in such a case, the entire HFM module housing 10 could be the latch), or a push latch system with one or two push latches, which disengage from a feature.

Optionally, as shown in FIGS. 1-15, the proximal portion 12 comprises a plurality of proximal end threads 46 located in the proximal portion interior 22 adjacent the proximal portion proximal end 14 (e.g., for attachment to a water bottle containing dirty water needing to be filtered). Optionally, the distal portion 24 comprises a plurality of distal end threads 48 located in the distal portion interior 36 adjacent the distal portion distal end 28.

Optionally, as shown in FIGS. 1-15, the distal portion 24 further comprises a screw cap 50 located adjacent to the distal portion distal end 28 and removably attached to the distal threads 48. Optionally, the distal portion interior 36 further comprises a washer 52 proximal to the screw cap 50.

Optionally, as shown in FIGS. 1-15, the distal portion interior 36 further comprises a stem 54 proximal to the screw cap 50. Optionally, the stem 54 is configured to mate to a syringe and comprises a stem length 56 parallel to the distal portion length 32. Optionally, the proximal portion 12 and the distal portion 24 each comprise a diameter perpendicular to the proximal portion and distal portion lengths 19,32, and optionally the stem 54 is located in a center of the distal portion diameter 58.

Optionally, as shown in FIGS. 1-15, the proximal portion interior and the distal portion interior 22,36 form a housing interior.

Optionally, like other HFM modules, the HFM module 10 comprises a filament housing 60 and a filament housing interior holding the plurality of porous filaments. The filaments are not shown but are well known to those of ordinary skill.

Optionally, as shown in FIGS. 1-15, the filament housing 60 comprises a filament housing exterior, and further wherein an O-ring 62 extends around the filament housing exterior. Optionally, the filament housing comprises a filament housing proximal end 64 distal to the proximal portion proximal end 14 and comprising a water inlet 66 and a filament housing distal end 68 proximal to the distal portion distal end 28.

Optionally, as shown in FIGS. 1-15, the proximal portion exterior 20 and/or the distal portion 24 comprise a plurality of fins 70 (e.g., for gripping while rotating the proximal portion 12 relative to the distal portion 24).

Optionally, as shown in FIGS. 1-15, the proximal portion and distal portions 12,24 are cylindrical in shape.

Optionally, the HFM housing 10 is comprised of metal or plastic. For example, the housing may be, for example, pressed, stamped or injection molded part (made of metal or plastic).

Optionally, the present disclosure provides a method of purifying water comprising: a) providing the HFM module housing 10; and b) flowing water through the proximal portion proximal end 14, through the HFM module 10 and out the distal portion distal end 28.

Part List

| | |
|---|---|
| HFM Housing | 10 |
| Housing proximal portion | 12 |
| Proximal portion proximal end | 14 |
| Proximal portion water inlet | 16 |
| Proximal portion distal end | 18 |
| Proximal portion length | 19 |
| Proximal portion exterior | 20 |
| Proximal portion interior | 22 |
| Distal portion | 24 |
| Distal portion proximal end | 26 |
| Distal portion distal end | 28 |
| Distal portion water outlet | 30 |
| Distal portion length | 32 |
| Distal portion exterior | 34 |
| Distal portion interior | 36 |
| HFM | 38 |
| Mating threads | 40 |
| Tab | 42 |
| Recess/divot | 44 |
| Proximal end threads | 46 |
| Distal end threads | 48 |
| Screw cap | 50 |
| Washer | 52 |
| Stem | 54 |
| Stem length | 56 |
| Diameter | 58 |
| Filament housing | 60 |
| O-ring | 62 |
| Filament housing proximal end | 64 |
| Filament housing water inlet | 66 |
| Filament housing distal end | 68 |
| Fins | 70 |

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention. In addition, the steps of any method described herein may be performed in any suitable order and steps may be performed simultaneously if needed. Use of the singular embraces the plural.

Terms of degree such as “generally”, “substantially”, “about”, and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

What is claimed is:

1. A hollow fiber membrane module housing (HFM module housing) comprising:
a) a proximal portion comprising a proximal portion proximal end comprising a water inlet, a proximal portion distal end, a proximal portion length extending from the proximal portion proximal end to the proximal portion distal end, a proximal portion exterior, and a proximal portion interior;
b) a distal portion comprising a distal portion proximal end, a distal portion distal end comprising a water outlet, a distal portion length extending from the distal portion proximal end to the distal portion distal end, a distal portion exterior, and a distal portion interior adjacent and distal to the proximal portion interior;
c) a hollow fiber membrane module (HFM module) located in the proximal portion and the distal portion interior and comprising a plurality of porous filaments; and
d) a latch removably securing the distal portion proximal end to the proximal portion distal end.

2. The HFM module housing of claim 1 wherein the latch comprises mating threads located on the proximal portion distal end and the distal portion proximal end.

3. The HFM module housing of claim 2 wherein the proximal portion interior and the distal portion interior form a housing interior, and further wherein the mating threads are located in the housing interior.

4. The HFM module housing of claim 2 wherein the latch further comprises a tab located on the proximal portion adjacent the proximal portion distal end and a recess removably receiving the tab and located on the distal portion adjacent the distal portion proximal end.

5. The HFM module housing of claim 1 wherein the proximal portion comprises a plurality of proximal end threads located in the proximal portion interior adjacent the proximal portion proximal end.

6. The HFM module housing of claim 1 wherein the distal portion comprises a plurality of distal end threads located in the distal portion interior adjacent the distal portion distal end.

7. The HFM module housing of claim 6 wherein the distal portion further comprises a screw cap located adjacent to the distal portion distal end and removably attached to the distal threads.

8. The HFM module housing of claim 7 wherein the distal portion interior further comprises a washer proximal to the screw cap.

9. The HFM module housing of claim 7 wherein the distal portion interior further comprises a stem proximal to the screw cap, wherein the stem comprises a stem length parallel to the distal portion length, wherein the proximal portion and the distal portion each comprise a diameter perpendicular to the proximal portion and distal portion lengths, and wherein the stem is located in a center of the distal portion diameter.

10. The HFM module housing of claim 1 wherein the proximal portion interior and the distal portion interior form a housing interior, wherein the HFM module comprises a filament housing and a filament housing interior holding the plurality of porous filaments.

11. The HFM module housing of claim 10 wherein the filament housing comprises a filament housing exterior, and further wherein an O-ring extends around the filament housing exterior.

12. The HFM module housing of claim 10 wherein the filament housing comprises a filament housing proximal end distal to the proximal portion proximal end and comprising a water inlet and a filament housing distal end proximal to the distal portion distal end.

13. The HFM module housing of claim 1 wherein the proximal portion exterior and/or the distal portion comprise a plurality of fins.

14. The HFM module housing of claim 1 wherein the proximal portion and distal portions are cylindrical in shape.

15. The HFM module housing of claim 1 wherein the HFM housing is comprised of metal or plastic.

16. A method of purifying water comprising:
a) providing the HFM module housing of claim 1; and
b) flowing water through the proximal portion proximal end, through the HFM module and out the distal portion distal end.
